(19) United States
(12) Patent Application Publication
(10) Pub. No.: US 2011/0094080 A1
(43) Pub. Date: Apr. 28, 2011

(54) BAR SOAP SUPPORT MAT

(76) Inventor: WILLIAM KARALES, Smithtown, NY (US)

(21) Appl. No.: 12/912,378

(22) Filed: Oct. 26, 2010

Related U.S. Application Data
(60) Provisional application No. 61/279,845, filed on Oct. 27, 2009.

(51) Int. Cl. B23P 11/00; B32B 3/26; D04H 1/00; B32B 5/00

(52) U.S. Cl. 29/428; 428/220; 442/327; 442/335; 428/219

(57) ABSTRACT

The bar soap support mat supports a bar of soap above a supporting sub-surface. The mat is fabricated from synthetic strands configured in random direction loop configurations forming interstices therebetween. This construction allows water to filter away from the soap and ambient air to flow around the soap bar, thereby enabling the soap to stay dry. Moisture and impurities are drained through the mat, thereby inhibiting the formation of scum on the soap bar and sub-surface. Rinsing with warm water can easily clean the mat.

### CROSS-REFERENCE TO RELATED APPLICATION

This application claims the benefit of U. S. Provisional Patent Application Ser. No. 61/279,845, filed Oct. 27, 2009.

### BACKGROUND OF THE INVENTION

1. Field of the Invention

The present invention generally relates to supports, and particularly to a bar soap support mat that allows water to filter away from the soap bar to maintain the soap bar in a dry state and to prevent the soap bar from sticking to the soap dish, shelf, or carrier where the soap bar would otherwise rest.

2. Description of the Related Art

Although the use of containerized liquid soaps and soap gels has become prevalent, there are still many consumers who prefer to employ the old-fashioned soap bar for general cleaning and personal hygiene. Unfortunately, using bar soap presents a myriad of problems relative to neatness and aesthetics. Water retained on a just-used soap bar produces a liquid film that contains dissolved soap and impurities from the person or item being washed. If allowed to dry, this film forms a residue referred to as soap scum. Besides being unsightly, the scum is relatively difficult to clean once it has dried on the soap and the surface of the soap-supporting structure, and causes the soap bar to stick to the soap-supporting structure. Furthermore, the retained water enhances soap bar erosion, thereby shortening the life of the soap bar and requiring the early purchase of another bar of soap. The art would certainly welcome a support that would function to efficiently filter water away from the soap bar, while enhancing the flow of air around the bar, whereby the bar is quickly dried and the incidence of soap scum inhibited. Thus, a soap bar support lift or mat solving the aforementioned problems is desired.

### SUMMARY OF THE INVENTION

The bar soap support mat supports a bar of soap above a supporting sub-surface. The mat is fabricated from synthetic; non-stick strands configured in random-direction loop configurations forming interstices therebetween. This construction allows water to filter away from the soap bar and ambient air to flow around the soap bar, thereby enabling the soap to stay dry. Moisture and impurities drain through the mat, thereby inhibiting the formation of scum on the soap bar and sub-surface. Rinsing with warm water can easily clean the mat. The mat also prevents the bar soap from sticking to the soap dish, shelf, or carrier where the soap bar would otherwise rest.

Accordingly, the invention presents a lift or mat for supporting a soap bar out of direct contact with a supporting sub-surface. The mat is constructed of durable, easily cleanable materials and is designed to permit ambient air circulation therethrough. The invention provides for improved elements thereof in an arrangement for the purposes described that are inexpensive, dependable and fully effective in accomplishing their intended purposes.

These and other features of the present invention will become readily apparent upon further review of the following specification and drawings.

### BRIEF DESCRIPTION OF THE DRAWINGS

FIG. 1 is an environmental, perspective view of a bar soap support mat according to the present invention, the mat being placed on a soap dish.

FIG. 2 is an environmental, perspective view of a bar soap support mat according to the present invention, the mat being housed in a travel container.

FIG. 3 is a perspective view of a bar soap support mat according to the present invention.

FIG. 4A is a perspective view of a bar soap support mat according to the present invention, the mat being cut in a first ornamental design shape.

FIG. 4B is a perspective view of a bar soap support mat according to the present invention, the mat being cut in a second ornamental design shape.

Similar reference characters denote corresponding features consistently throughout the attached drawings.

### DETAILED DESCRIPTION OF THE PREFERRED EMBODIMENTS

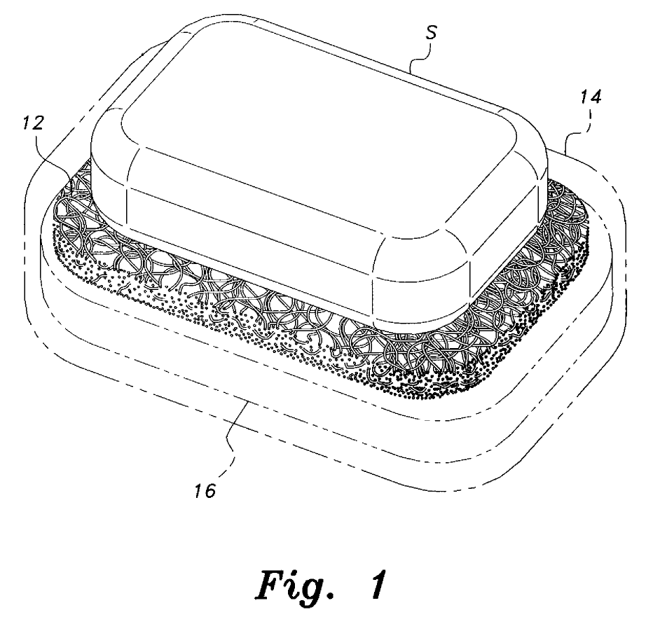

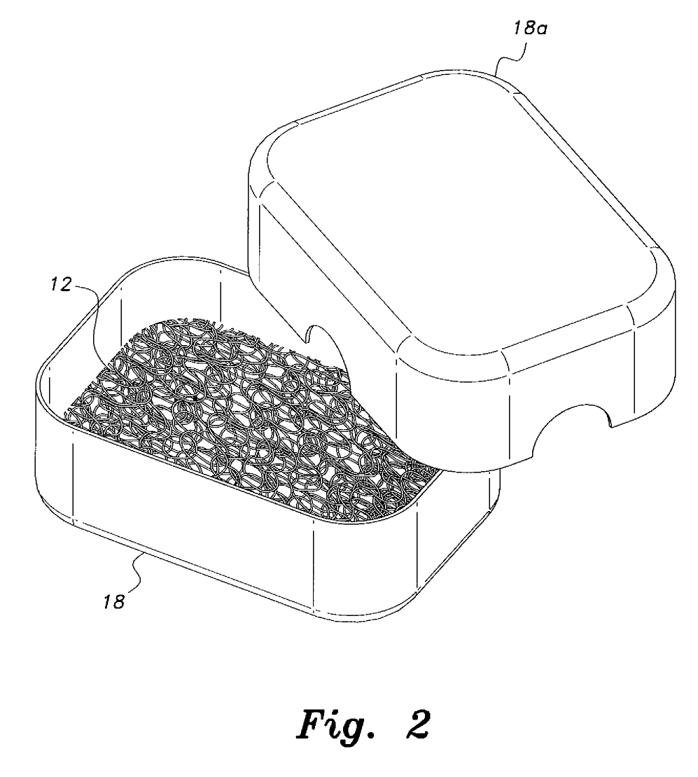

Referring to FIGS. 1 and 2, the bar soap support mat 12 is shown in FIG. 1 with a soap bar S supported thereon, the mat 12 being disposed on a sub-surface, such as a soap dish 16. The mat 12 may be supported in or on any conventional structure 14 (soap dish, shelf, carrier, etc.). FIG. 2 shows the mat 12 housed in a travel container 18 having a lid 18a. As noted above, the mat 12 allows water to filter away from and ambient air to flow around the soap bar, thereby enabling the soap to stay dry and inhibiting the formation of scum on the soap bar and sub-surface. The mat 12 also prevents bar soap from sticking to the soap dish 16, travel container 18, or other supporting surface

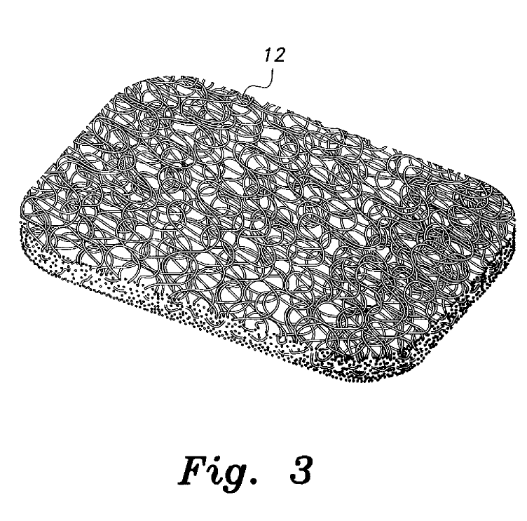

As best seen in FIG. 3, the mat 12 is constructed from plastic strands or fibers matted together and arranged in random direction loop configurations so that the mat 12 forms a mesh-like pad having interstices therein, each interstice forming an opening having an average open area of approximately 0.26 inches by 0.26 inches. The strands are preferably fabricated from prime, flexible PVC (polyvinyl chloride) material. It should be noted however, that other plastic material might be utilized, if suitable. Each strand is approximately 0.034 inches in diameter and has a hardness of 70 A as measured on a durometer. The mat weighs approximately 250 grams per sq. ft. and can be manufactured in several thicknesses, depending on its intended use. It has been determined that a mat thickness of approximately 0.360 inches works best for general use.

Any build-up of soap on the mat 12 can be cleaned by simply rinsing the mat 12 in warm water so that the mat 12 can be re-used.

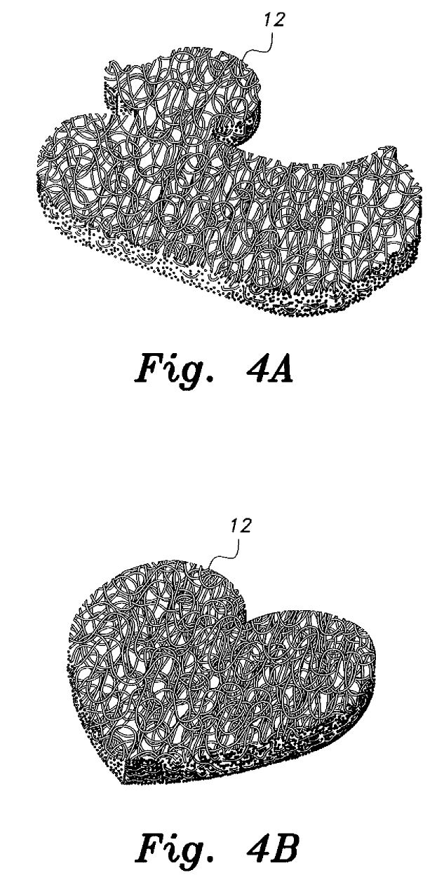

To satisfy various aesthetic tastes, the pad can be cut in almost any decorative shape, examples of which are shown in FIGS. 4A (duckling) and 4B (heart). The mat 12 can also be manufactured in various colors.

It is to be understood that the present invention is not limited to the embodiments described above, but encompasses any and all embodiments within the scope of the following claims.

I claim:

1. A bar soap support mat, comprising a plurality of plastic strands arranged in random loop configurations and matted together to form a mat, the mat having interstices formed between the plastic strands to allow ambient air flow therethrough, the interstices being dimensioned and configured to allow drainage of soap film dripping from the bar soap.

2. The bar soap support mat according to claim 1, wherein the mat has a thickness of approximately 0.360 inches.

3. The bar soap support mat according to claim 1, wherein each said strand has a diameter of approximately 0.034 inches.

4. The bar soap support mat according to claim 1, wherein the mat has a weight of approximately 250 grams per square foot.

5. A bar soap support mat, comprising a mat having a thickness of approximately 0.360 inches, the mat being fabricated from a plurality of polyvinyl chloride (PVC) strands arranged in random loop configurations, the mat having interstices formed between the PVC strands to allow ambient air flow therethrough, the interstices being dimensioned and configured to allow drainage of soap film dripping from the soap bar.

6. The bar soap support mat according to claim 5, wherein each said strand has a diameter of approximately 0.034 inches.

7. The bar soap support mat according to claim 5, wherein the mat has a weight of approximately 250 grams per square foot.

8. The bar soap support mat according to claim 5, wherein each interstice defines an area of approximately 0.26 inches by 0.26 inches.

9. A bar soap support mat, comprising a mat having a thickness of approximately 0.360 inches, the mat being fabricated from a plurality of PVC strands arranged in random loop configurations, each of the strands having a diameter of approximately 0.034 inches, the mat having interstices formed between the PVC strands to allow ambient air flow therethrough, each of the interstices defining an area of approximately 0.26 inches by 0.26 inches to allow drainage of soap film dripping from the bar soap.

10. The bar soap support mat according to claim 9, wherein the mat has a weight of approximately 250 grams per square foot.

11. A method of supporting bar soap, comprising the steps of:
placing the bar soap support mat according to claim 1 on a support; and
placing the bar soap on the mat;
whereby the bar soap is prevented from sticking to the support.
